(19) United States
(12) Patent Application Publication
(10) Pub. No.: US 2010/0199166 A1
(43) Pub. Date: Aug. 5, 2010

(54) Image Component WEB/PC Repository

(76) Inventor: Charles Mario Fisk, III, (US)

Correspondence Address: Charles Mario Fisk, 21407 Encio Ash, San Antonio, TX, 78259, US

(21) Appl. No.: 12/365,860

(22) Filed: Feb. 4, 2009

(51) Int. Cl. G06F 3/048; G06F 17/00; G06F 15/16; G06F 17/30

(52) U.S. Cl. 715/230; 715/760; 715/752; 715/810; 707/E17.009

(57) ABSTRACT

A solution that organizes dispersed collections of images such as photographs, pictures and other graphical objects kept in shoeboxes, albums, or electronic storage. The solution makes it easy to describe, resize, index, and sort the different aspects contained in images. Facilities include documentation, e-mail, updating, version control, inclusion of video, embellishment, sound, animation, text to speech and, dynamic search.

It is an internet application that facilitates annotation, organizes, researches and shares images and corresponding information collected at different times and places. It links and relates images that share common elements. The same person found as a child in one image, as an adult in another, and referenced in a newspaper article is a relation example. This solution collects the knowledge embedded in multiple images and produces well documented, organized, and clearly explained printable images as well as dynamic albums of related images.

### CROSS-REFERENCE TO RELATED APPLICATIONS

This application replaces U.S. Provisional Patent Application No. 61/025,646 filed Feb. 1, 2008.

### FIELD OF THE INVENTION

The invention is an internet and personal computer based interactive application used to describe, organize, search, and share images.

### BACKGROUND OF THE INVENTION

People have collections of photographs dispersed in shoeboxes, albums, electronic storage, or other media.

The saying “a picture is worth a thousand words” is misleading; a picture without words becomes harder to understand with the passing of time. The questions of who is in the picture, where, why and when was it taken, oftentimes remain unanswered and valuable information is lost.

The invention seeks to protect image information from loss as well as to enrich documentation using research and sharing.

Use this invention to describe, organize, and research images collected at different times, in different places. The invention links and relates images sharing similar components. The same person found as a child in one image, as an adult in another, and as referenced in a newspaper article is a relation example (FIG. 17).

The purpose of the invention is to collect the knowledge of many people to produce well documented, organized and clearly explained picture albums. This invention extends the social information explosion brought about by success stories such as You Tube, Face Book, and My Space. This invention e-mails images and the information about the images first to friends and family who are better equipped to add content including new related images (FIG. 1). The invention optionally stores the documented images in a central web repository so that any person can search and add new discovery (FIG. 19).

### PRIOR ART

1. U.S. Pat. No. 6,408,301 Patton, et al. Jun. 18, 2002

2. U.S. Pat. No. 6,434,579 Shaffer, et al. Aug. 13, 2002

3. U.S. Pat. No. 6,690,843 Squilla, et al. Feb. 10, 2004

4. U.S. Pat. No. 6,745,186 Testa, et al. Jun. 1, 2004

5. U.S. Pat. No. 6,873,336 Sailus, et al. Mar. 29, 2005

6. U.S. Pat. No. 7,028,253 Lieberman, et al. Apr. 11, 2006

7. U.S. Pat. No. 7,028,900 Capozzi, et al. Apr. 18, 2006

8. U.S. Pat. No. 7,068,309 Toyama, et al. Jun. 27, 2006

9. U.S. Pat. No. 7,120,619 Drucker, et al. Oct. 10, 2006

10. U.S. Pat. No. 7,149,755 Obrador Dec. 12, 2006

11. U.S. Pat. No. 7,243,301 Bargeron, et al. Jul. 10, 2007

12. U.S. Pat. No. 7,260,587 Testa, et al. Aug. 21, 2007

13. United States Patent Application 20020054059 Kind Code A1 Schneiderman, B. A. May 9, 2002

### SUMMARY OF THE INVENTION

The internet facilitates new discovery about any single image because a wider audience is involved. Search, exchange, and intelligence gathering continuously enrich the history behind the image. The process promotes the discovery of other images bearing a relationship that otherwise would not be known.

### The Web Server

Is the central location accessible from the internet, it holds the embodiments to run on a personal computing device, it stores member information in a centralized repository and it holds embodiments to remotely support the application on personal computing devices (FIG. 19).

The Server Interface connects the WEB server (home of the invention) with the user base. Individuals use the interface to search, upload, and download information (FIG. 19).

The Web Server repository stores Image Objects in the corresponding member directories. An index of key information extracted from the Image Objects optimizes the search embodiment. (FIGS. 17 and 19)

The repository search engine searches and links images that share common elements as dictated by the search criteria (FIG. 17).

The WEB Server contains a separate personal computing subset (PCS) embodiment of the invention, used stand-alone on a personal computing device (some examples are PC, PDA, and Internet TV) (FIG. 19).

The personal computing subset provides embodiments to browse within the users personal computer, select images and convert them into Image Objects (FIG. 2).

The personal computing subset provides embodiments to create new albums and add new Image Objects (FIGS. 13 and 14).

The WEB Server repository index has all the identified key names of objects submitted to the server; this includes images, image parts, member names, and folder locations (FIG. 19).

The WEB Server and the PCS maintains a history of changes made to Image Objects.

A newly submitted image data automatically launches a WEB Server search for other images that contain aspects related to the new data. The server e-mails the search results to the owner of the image.

The Picture or Image Object encapsulates the image, its overall description, and embodiments to view, maintain, and update the Image Object plus the ability to create new objects (FIG. 3).

The Help embodiment guides the user throughout the process (FIG. 16).

The zoom embodiment resizes the image for maximum detailed analysis as well as to fit the screen of the user's personal computing device.

The screen options embodiment controls the presentation of the Image Object with drop down menus and short hand key command mode. The command mode optimizes the image on the screen and is useful for small devices such as PDA. (FIG. 3)

The frame component embodiment allows the user to surround selected image component parts (such as people, places or other things) with a visible frame that automatically resizes to the overall zoom level of the image. Pinpointing a component (using a mouse or touch) causes the frame and the corresponding information to become visible and ready for annotation (FIG. 5).

The component annotation embodiment allows the user to clearly explain, modify, or change information about any image aspect (FIG. 5).

The component annotation embodiment allows the user to delete selected image components.

The image story embodiment allows the user to provide details as to when, why, what and where it was originally created (FIG. 4).

The foreign character embodiment allows the user to insert foreign characters when they are not available in the keyboard or keypad.

The animation and text to speech optional embodiments allow the presentation of image descriptions using animated characters and digitized speech (FIG. 12).

The music and video optional embodiments enrich the image story (FIG. 15).

The background and decoration embodiments add attractive presentation to the image story (FIG. 11).

The display mode embodiments allow the users to view the overall image description as well as it component parts (FIG. 15); animation and digitized speech are optional.

The regenerate embodiment saves new versions of the Image Objects called Child

Image Objects, which inherit the elements of the original object and include new information.

The e-mail embodiment allows users to send updates or exchange information with other image owners. (FIGS. 1 and 19)

The print preview embodiment allows the user to sample the Image Object prior to printing. (FIG. 18)

The save embodiment stores the Image Object in a personal computer hard disk.

The submit embodiment stores the completed Image Objects in the WEB repository (FIG. 19).

The new Image Object embodiment invokes the interface to select a new image and create a new object.

The new Album embodiment invokes the Create Album interface. This interface searches and collects Image Objects that share common selection criteria. (FIG. 13)

### BRIEF DESCRIPTION OF THE FIGURES

FIG. 1. Supported by the ICS server, Image Objects exchanged electronically from user to user enhance the opportunity for new discovery.

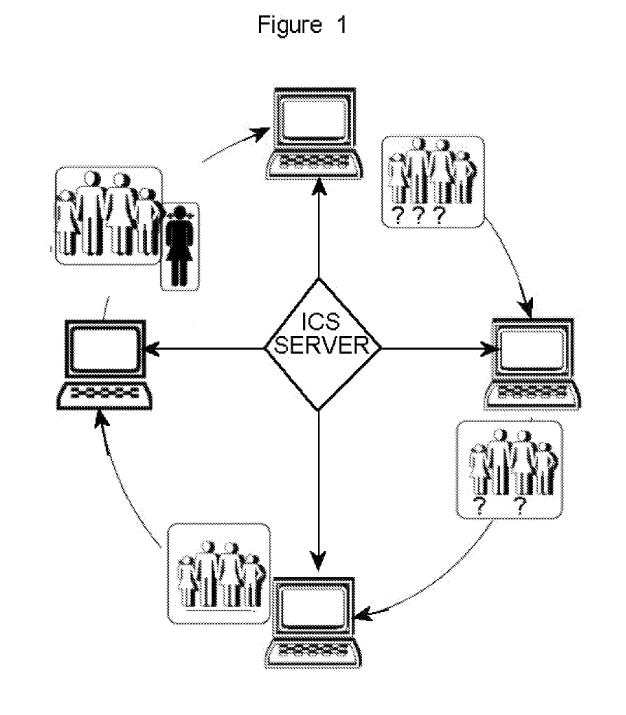

FIG. 2. The interface used to generate Image Objects.

FIG. 3. The newly created Image Object represented in the foreground as an envelope contains the image, image annotations and mechanisms to control the presentation on the screen shown in the background.

FIG. 4. The Image Object embodies the capability to write a story about the image.

FIG. 5. The annotation form shown on the screen alongside a highlighted resizable frame, enables information entry for the highlighted area.

FIG. 6. The frame submenu enables additional commands pertinent to the frame itself. If the image is resized the frame is also proportionally sized and retains the position over the highlighted aspect.

FIG. 7. The resizable frame reduced to a small dot marks small areas of the image.

FIG. 8. To facilitate identification of image components the story embodiment places markings on the edge of the picture with corresponding superscripts to the side of each component name. The markings are useful when the object is printed.

FIG. 9. An index to all the annotated image aspects identifies the corresponding component areas.

FIG. 10. The computer displays all the annotations made to the image

FIG. 11. Selection options from multiple drop cap embellishment designs.

FIG. 12. Sample animation includes text to speech.

FIG. 13. The Album Generator interface relates annotated images that share common aspects as defined by specified selection criterion.

FIG. 14. The Picture Album contains a cover, table of contents, and index all hyperlinked to the corresponding annotated images.

FIG. 15. The Image Object displays videos included by the user.

FIG. 16. A section of the help manual displayed over the Image Object.

FIG. 17. A conceptual view of the Image Object repository, top row represents images stored in the repository. The left hand column represents three different selection choices. The second through third rows represents the selection results.

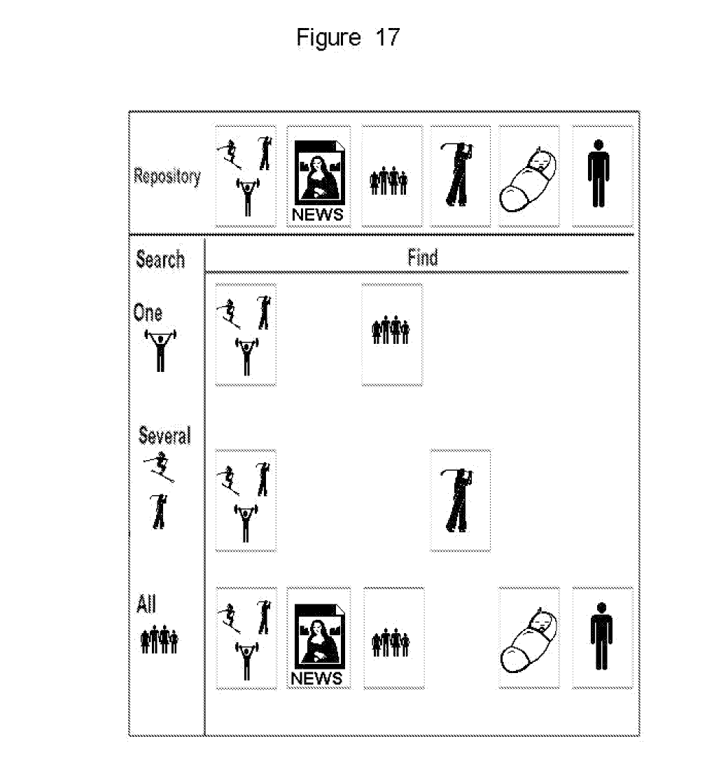

FIG. 18. Image Object print preview.

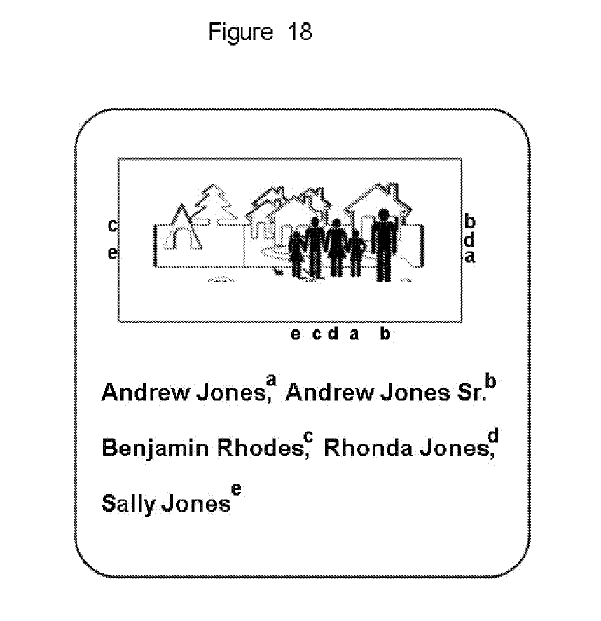

FIG. 19. The Image Component WEB/PC Server supports users in multiple ways.

### EMBODIMENT

### Access Image Component WEB/PC Repository (The Invention)

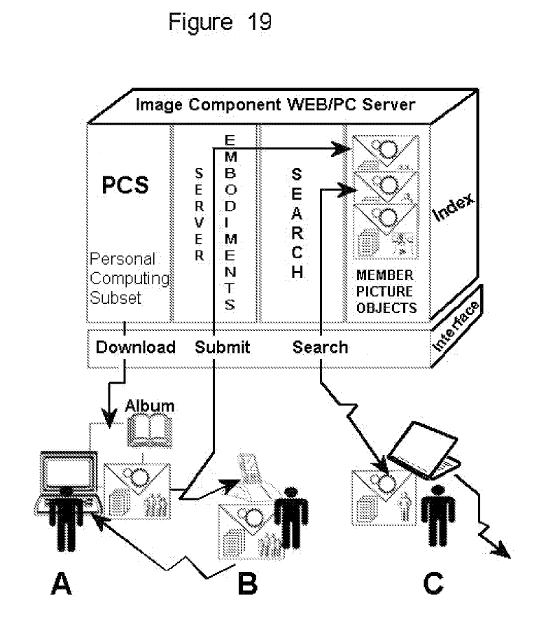

The invention can be used in several ways:
1. The user's personal computer only: In this case, the Image Object Generator (an html web page) downloads and installs in the user's personal computer. The Image Album Generator also downloads and installs on the computing device. (FIG. 19-A)
2. The user wishes to exploit the methods downloaded to the personal computing device as well as the web server data sharing facilities, in this case server registration is required. (FIG. 19-A)
3. The user works loosely dependent of the WEB server (FIG. 19B-C).

Download the PC Component

Individuals have the option to install the invention on a personal computer without the need of becoming members of the web server; in this case, the users retain all the organizational facilities of the invention with the ability to share information on the internet using e-mail. (FIG. 19-A)

Help

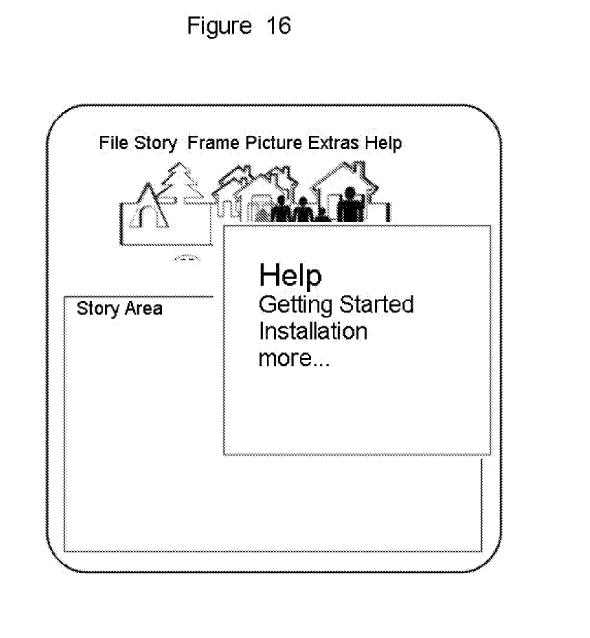

The Help embodiment is available throughout all the processes. (FIG. 16)

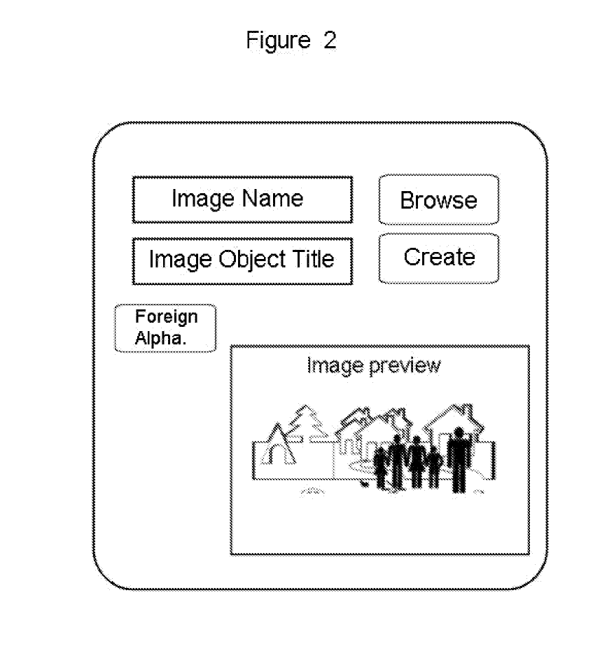

Image Object Generator (FIG. 2)

Generation of new image or picture objects requires saving and running the Image Object Generator (a simple html interface) downloaded as part of the PC Component mentioned above.

Using the html interface the user browses the local computer, selects an image, provides a title, and generates the corresponding Image Object.

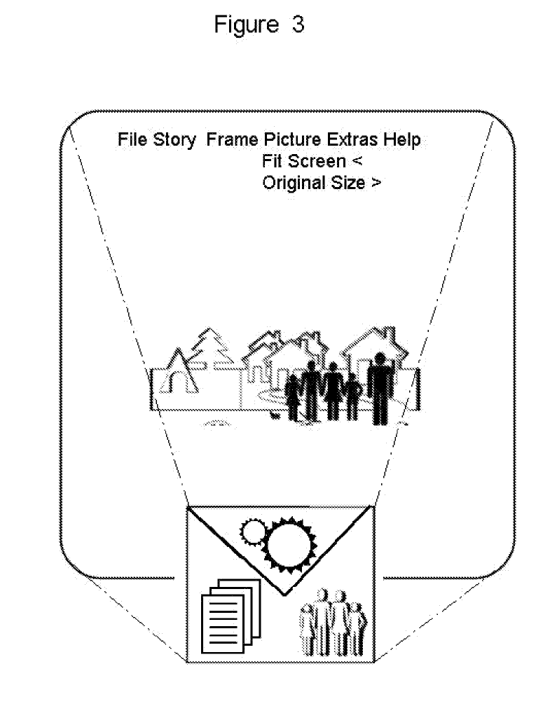

Image Object (FIG. 3)

Image Objects are resizable, allow descriptions, embellishments, component identification, and become searchable and shareable by multiple users connected to the internet.

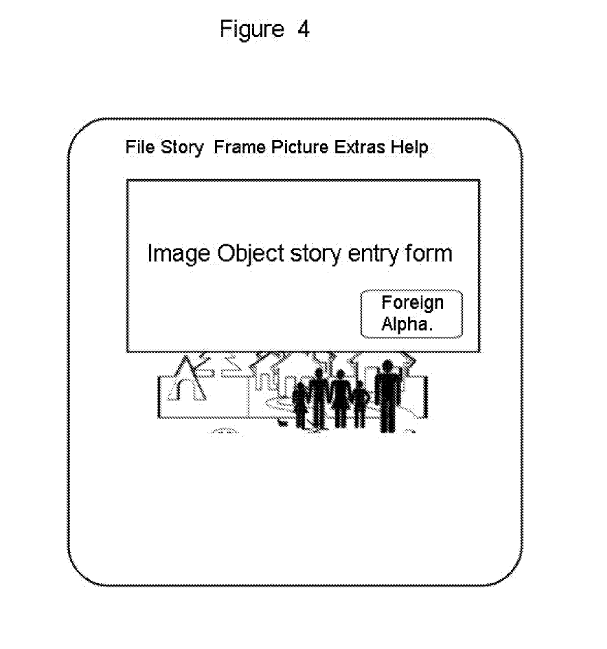

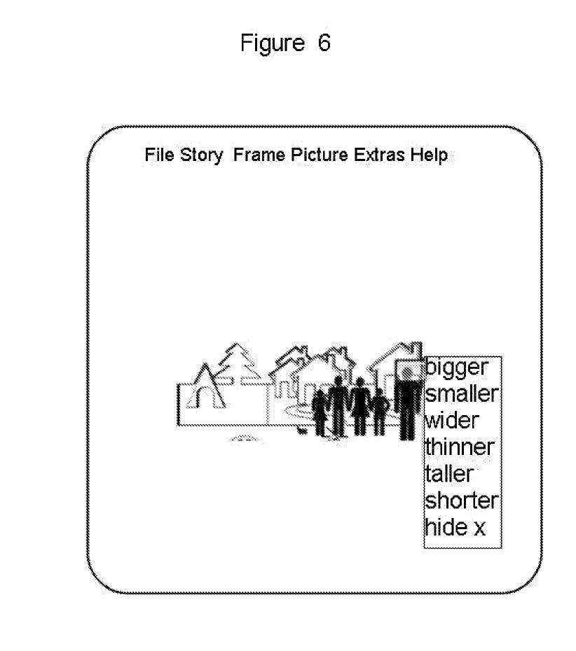

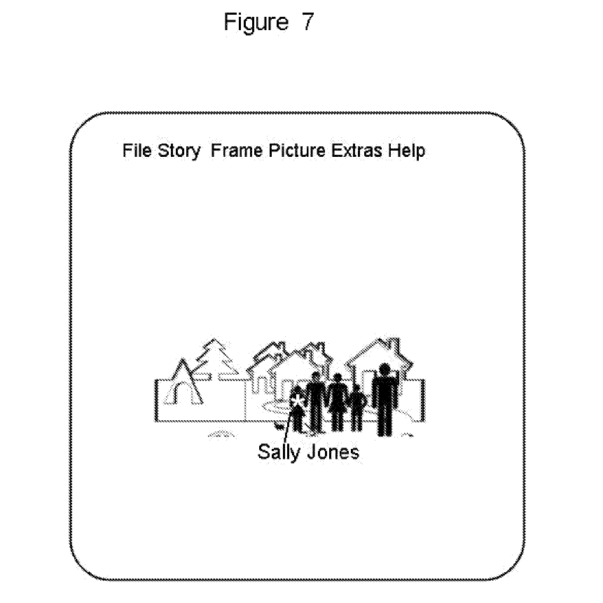

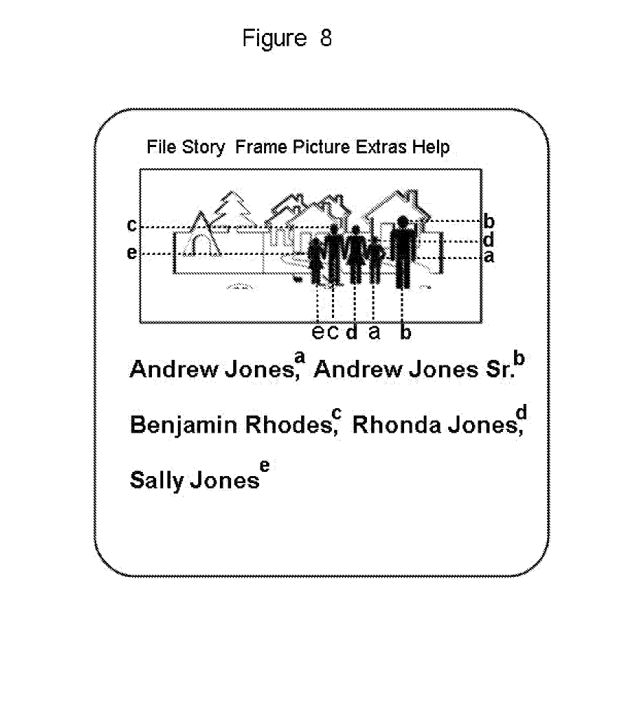

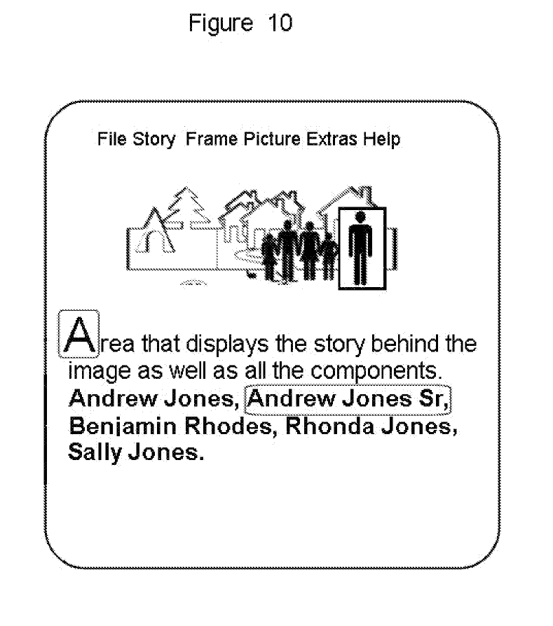

The Image Object allows the user to highlight, resize, and describe the different things that appear in the selected image. (FIGS. 4-12)

Commands execute using short cut keys or the drop down menus included in a tool bar.

The tool bar view displays all commands in drop down menus (FIGS. 3, 6, and 11).

Key driven commands use the keyboard; this optimizes the presentation of the image in the available screen space and is better suited for cell phones and other small internet devices (FIG. 3).

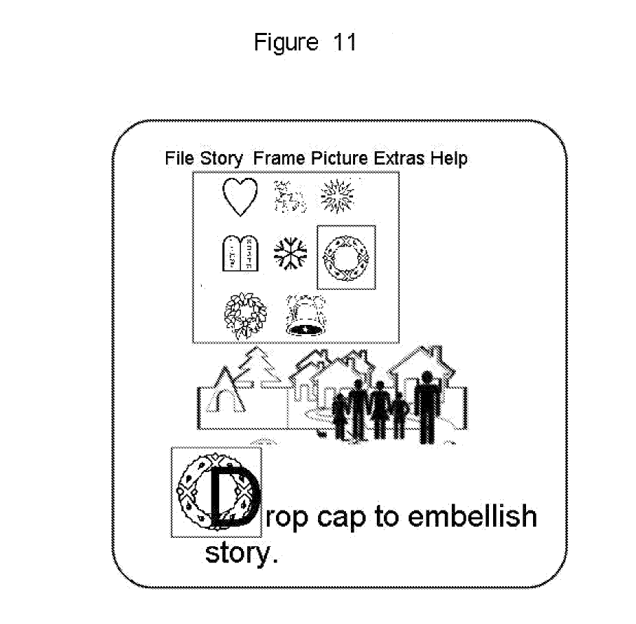

To enhance the presentation tools are provided which allow adding animation, text to speech, video, thumbnails and other embellishments. (FIGS. 11, 12, and 15)

The user names and saves the newly created Image Object.

Modifications made to a pre existing Image Objects saves as a new version called a Child Image Object.

Describe the Image History

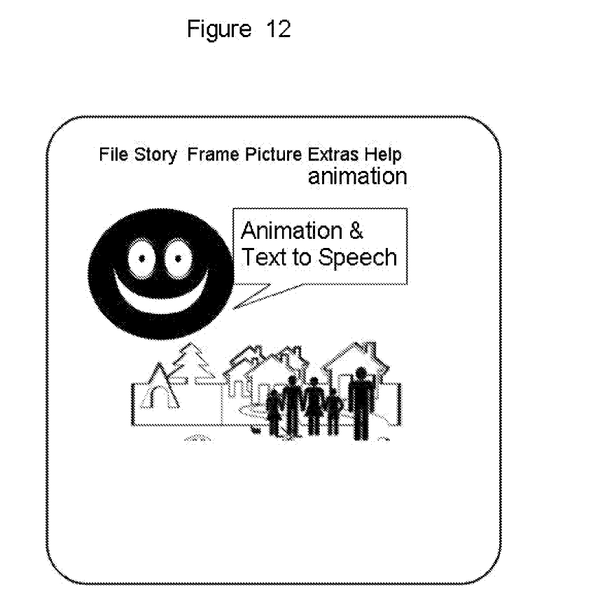

The user describes the image history, provides appropriate titles, and includes the time and place of original creation. Animation and text to speech options add value to the overall presentation of the image (FIGS. 4 and 12).

Identify and Describe the Image Components

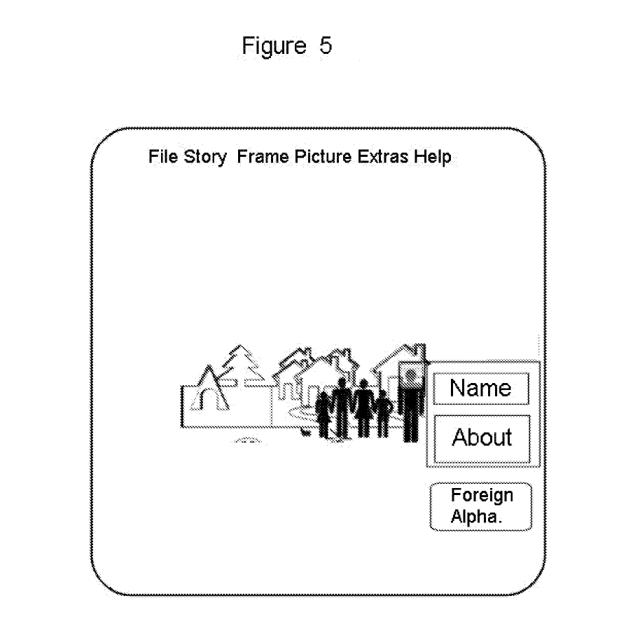

Components included in the image (people, objects, places, etc.) are identified by resizable frames and individually described including names, dates and other pertinent information (FIG. 5).

Support Foreign Characters

Keypads and keyboards do not support all types of foreign characters (example Spanish n, accented etc.). In order to display foreign characters the users enters a combination of characters. Pressing the foreign character button displays the proper foreign characters. (for example n˜ will become ñ) (FIGS. 2, 4, and 5)

Support for Animation

Optional inclusion of animated characters add interest the overall image as well as each individual component. The animated characters take different postures in line with the directions selected by the user. (FIG. 12)

Optional text to speech uses the animated characters to read the textual data included in the Image Object.

Support for Music.

The user has the option to include musical backgrounds in the Image Object.

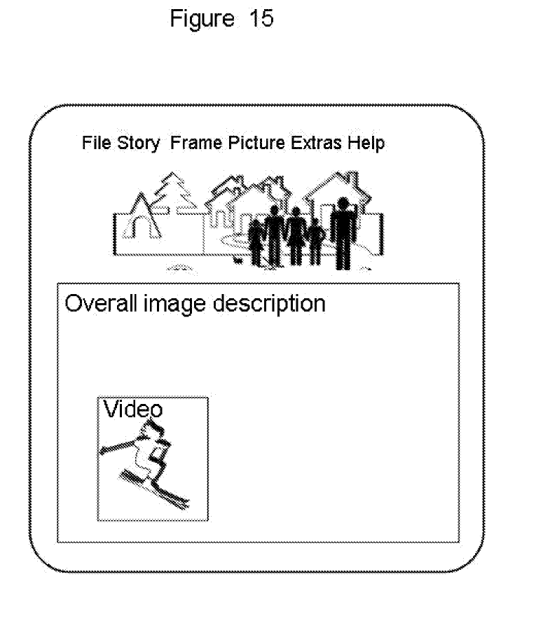

Support for Video. (FIG. 15)

Optional inclusion of video enhances the attraction of the image option.

Letter Styles

Various letter styles choices available allow different combinations of color, font, sizes, and boldness.

Decorations (FIG. 11)

Various drop cap designs available, (large initial letters or words at the start of a paragraph or document), add style and focus to the documented image. The user has the options to add new designs.

### BACKGROUND

Various background designs available add interest to the Image Object. The user has the option of adding new backgrounds.

Resize the Image

Optionally it is possible to enlarge or reduce the Image Object displayed in the computer screen. Enlarged images facilitate positioning a frame around an aspect that otherwise would de difficult to distinguish. Image enlargement and reduction allow optimal presentation and composition of the final picture object.

Resizing the image keeps the aspect ratio and position of the component frames.

Handling of Previously Identified Components

Placing the computing pointing device (i.e. mouse, touch) over a previously framed component displays the corresponding data and allows changes, additions, or deletions of information.

Index the Identified Components

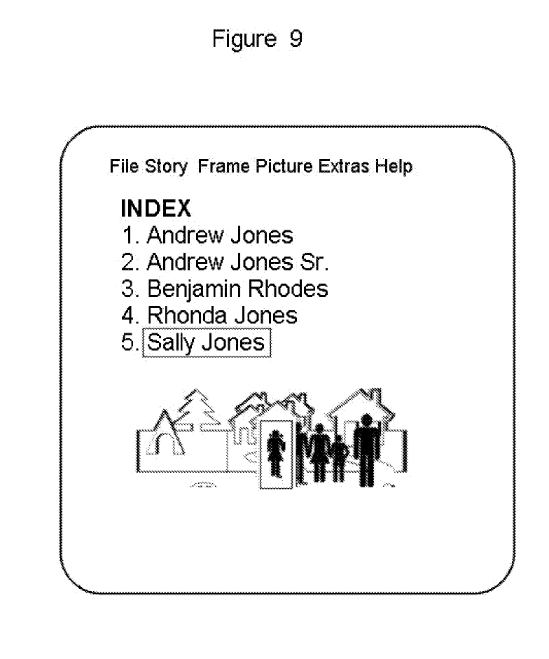

An index embodiment facilitates the identification of image components (FIG. 9).

Placing the computing pointing device (i.e. mouse, touch) over an index name displays the component data and allows information changes, additions, or deletions.

Relate Components to the Overall Description

Placing the computing pointing device (i.e. mouse, touch) over a component name mentioned in the image history displays the corresponding data and allows changes, additions, or deletions of information.

Save the Image Object, Create Additional Objects

The user saves the fully described and properly titled Image Object in a personal computer file and proceeds with the creation of additional Image Objects. Image objects are stored with links to music, videos, and/or animations.

Search, Update, and Delete Unwanted Image Objects.

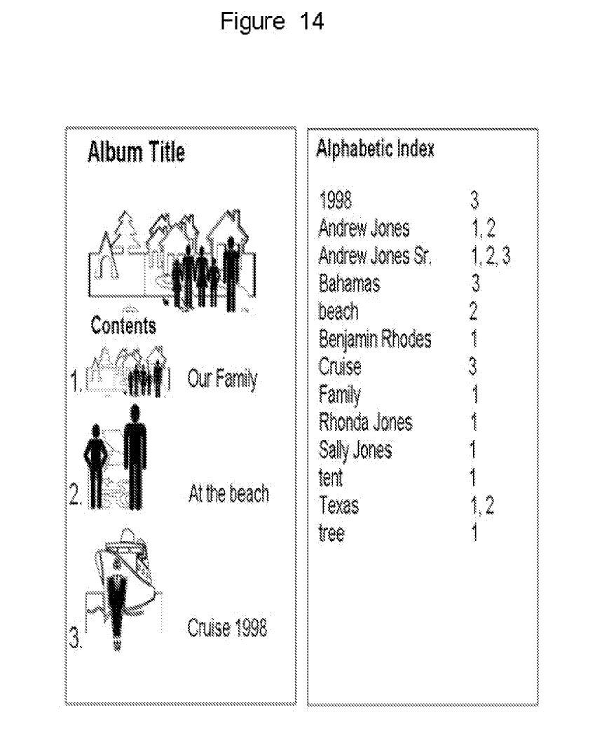

Create, organize, and save images into albums (FIG. 14)

Presentation and Printing of Image Objects

The image story embodiment displays the overall story that describes the picture as well as all identified components (sorted alphabetically). Descriptions display below or beside the Image Object. The left and bottom margins of images optionally display markings that point to the position of the image components.

In another embodiment, a print preview facility allows the user to prepare the final composition to be printed.

Internet Support

In another embodiment internet communications e-mail support is an integral part of the Image Object.

In another embodiment internet communications submit to WEB server is an integral part of the Image Object.

Create Albums

Albums (FIG. 14) refer to a collection of images that share certain common characteristics. In this embodiment albums are saved as WEB Pages with
1. A table of contents (has all the Image Object titles).
2. An index of keywords composed of capitalized names and nouns.
3. Both the table of contents and the index link to the corresponding Image Objects in exactly the same way that used in book publications.
4. After the front cover, the table of contents opens the album, followed by the Image Objects and closed by the index.

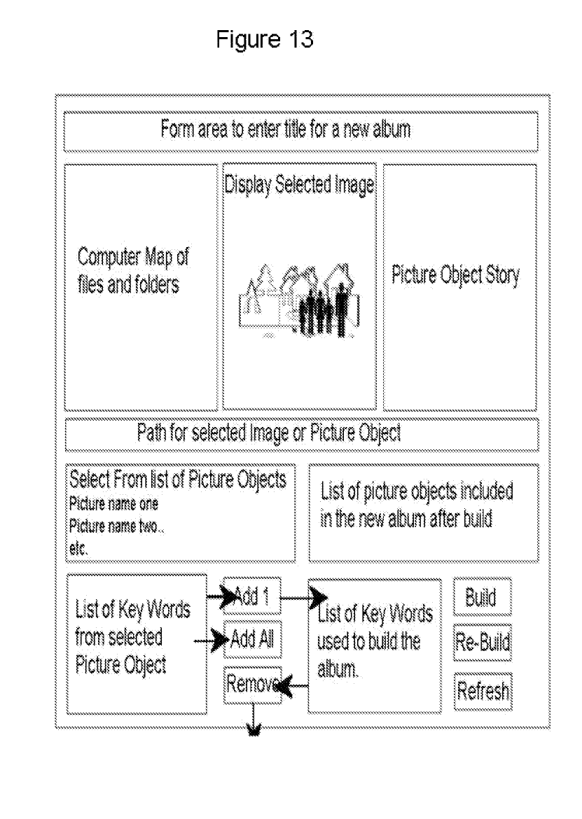

The image album tool is part of the Personal Computing embodiment downloaded from the web server. It collects the images objects that share some common properties and include them in a picture album (FIG. 13).

The image album tool has several selection options. The preferred option consists in choosing one picture object (called the anchor object) as the source of data to search within all other picture objects. In this embodiment every the key word contained in the anchor are used to select other picture objects that contain at least one key word.

The album tool has a search engine that contains hundreds of popular nouns. Nouns will be added to the index (at the back of the album) if a searched object becomes part of the album.

Searched objects become part of the album and the table of contents provided capitalized names (excluding common words that begin a sentence) exist in the anchor and the searched object.

Searched objects add to the album if anchor titles, sub-titles, places, and dates share commonality with the searched object.

Another embodiment of the search criteria permits exclusion of anchor keywords and inclusion of new words not available in the anchor.

Yet another embodiment excludes the anchor object altogether and a list of user provided keywords becomes the search criteria.

Yet another embodiment of the selection process displays a suggested, preliminary view of the album. Under this embodiment, the user deletes one or more selected Image Objects because they do not actually represent the optimal set of images.

Yet another embodiment recreates the album using the desired set of picture objects.

The user designs the picture album cover by choosing a background picture, text format and color schemes.

The album includes front and back covers, title, introductory page, contents page, the pictures, and a back alphabetical index of topics. (FIG. 14)

Each entry in the table of contents and the alphabetized index links to a corresponding Image Object.

A high-level index provides hyperlinks between related WEB Page Albums.

Create Volumes and Libraries.

In this embodiment, albums related to other albums collect into volumes. Related volumes constitute libraries.

Embellish Albums, Volumes, and Libraries

Embellishments are available for Image Objects, albums, and libraries: animation and text to speech options, music, video, backgrounds, fonts, and drop caps.

Print Albums, Volumes, and Libraries

This embodiment prints Image Objects, albums, volume, or libraries. The preferred environment, prints using the browser print preview; other embodiments include Microsoft Word or PDF.

In another embodiment, the above collections print at an outside facility.

Submit New Image Objects

This embodiment applies to users who wish to store Image Objects on the WEB Server and share and research across the internet. Users that have installed the PC subset may or may not make use of this option.

Access Image Component WEB Server

In this embodiment, an individual using a web browser links to the main interface of the Internet Server. In a preferred embodiment, new individuals establish membership.

In yet another embodiment, existing members sign in to the secure server.

Create Member Directory

As soon as a new member is accepted, the system automatically creates a member directory a folder in which to store image or picture objects.

Browse PC Image Objects, Send to Web Server

The browser provided by the computing device does selection of Image Objects and albums. The user validates the selected items and proceeds with “Submit Objects, Verify Content.”

Submit Objects, Verify Content

The WED server administration analyzes the submitted objects for acceptable content.

Rejected objects return to the sender with an explanation including recommended changes.

The WEB server global index appends key words extracted from the accepted objects (FIG. 19).

The WEB server stores the accepted Image Objects in the corresponding member's folder (FIG. 19).

The Repository Global Index

The repository maintains a global index.

The global index directory contains key information for all images, ownership, and component parts.

Relate Submitted Objects to the Repository Global Index

The repository engine compares the newly submitted objects to those previously stored in the repository and produces a list of image locations that have matching items.

The owner of the newly submitted object uses the list to research previously stored image. This is a key feature because it provides new relationships with the recent submissions.

Search the Image Component Web Repository

An individual using a WEB browser links to the main interface of the invention and selects “Run Repository Search.”

Run Repository Search

The search engine allows the user to search by any combination of key words, quoted sentence, period, or physical location.

Proceed with “View Search Results.”

View Search Results

Search results display a hyperlinked list of in all Image Objects that meet the search criteria.

Clicking on a desired hyperlink displays the corresponding image on the screen of the computing device.

Save Selected Image Objects in Local PC

The user downloads the desired Image Objects, saves them in a local PC folder, and proceeds to study them.

1. A method to describe and document the contents of digital images displayed on a computer that supports an internet browser. Embodiments to the Image Object provide facilities to annotate, embellish, enhance with video, music, animation, speech as well as update, sort, search and collect into digital albums. Documented digital images (called image or picture objects) operate at multiple levels, the lowest level being the local computer files, followed by other external locations, networks and the internet. A web server provides the functionality to run on any computing device and browser (FIG. 19).
a. A preferred embodiment according to claim 1 whereby the user chooses to run only on a personal computing device connected with supporting methods that run on the internet server. This embodiment creates Image Objects to be stored in the local computing device as well as exchanged using e-mail with any other person that is uses an internet browser.
b. Another preferred embodiment whereby the user extends the capability of 1a and submits, stores, researches and exchanges information using the internet server database (called Repository)
c. Another less preferred embodiment whereby the user installs all the server functionality in an independent network.
d. All mentioned embodiments have help, error detection, and warning messages.

2. A method according to claim 1a accesses a web server and retrieves a small data compression and archive format file.

3. A method according to claim 2 which after decompression installs an Image Object Generator and displays it on the screen of the computer device.

4. According to claim 3, the Image Object Generator includes a help facility.

5. According to claim 3, the Image Object Generator includes a browsing facility to select and preview an image.

6. According to claim 3, the Image Object Generator includes a facility to create a name (Title) for a new Image Object.

7. A method according to claim 1 whereby the name (annotation) of the Image Object allows entry of character types not available in the keyboard or keypad (i.e. Spanish n). This claim extends to all forms used to enter data in all embodiments of the invention.

8. According to claim three (3), an embodiment of the Image Object Generator constructs a new Image Object.

9. A method according to claim 1 whereby the Image Object created detects the type of browser and computing device and invokes the appropriate functionality exploit the environment in which it is running.

10. A method according to claim 1 whereby the Image Object displays on the screen of the device
a. The required image
b. A resizable frame that can be positioned anywhere inside the image area.
c. A drop down menu that includes short cut key commands
d. Changes made to the information contained in the object, prompt a save warning to display on the computer screen.

11. A method according to claim 10a whereby the image can be increased or decreased in size and the resizable frame maintains the relative coordinate position and size in proportion to the image height to width aspect.

12. A method according to claim 10b whereby the Image Object Generator includes a menu and shortcut keys to
a. Drag and position the frame over a selected screen area (i.e. a face).
b. Increase or decrease the frame in any direction.
c. Hide or show the frame.
d. Make the frame into a single point (called a dot).
e. Provide coordinate guides within the image.
f. Provide a text entry form to describe, update, edit, or delete the specific area surrounded by the frame.

13. A method according to claim 10c whereby the Image Object Generator includes a menu and shortcut keys to
a. Save a new Image Object with all changes included.
b. E-mail the Image Object to another location or person (claim 1).
c. Submit the image album to the web server (claim 1b).
d. Start a completely new Image Object (invokes the Image Object Generator see claim 3).
e. Open another existing Image Object.
f. Open an existing image album.
g. Start a new image album.

14. A method according to claim 10c whereby the Image Object Generator includes a menu and shortcut keys to
a. Provide a text entry form to describe the overall story behind the image, including titles, locations, dates, and authors.
b. Invoke an index of all image aspects included in the image.
c. Add or change letter styles, font, color, and size.
d. Add or change background colors and designs.
e. Add decorations (including illuminations and drop caps)
f. Preview the overall presentation of text and image, make corrections, and replace sections of text prior to saving and or printing.

15. A method according to claim 10c whereby the Image Object Generator includes a menu and shortcut keys to
a. Embed extensions that add attractions to the Image Object are music, animations, text to speech, and video.
b. Preview the overall presentation of text and image, make corrections, and replace sections of text prior to saving and or printing.

16. A embodiment of the Album Generator Interface according to claims 1 and 2 which; runs searches, collects, and organizes Image Objects into albums. (FIG. 13)
1. Includes a method to select an Image Object to be used as the anchor image to search for other images that have common characteristics (see item 38).
2. The embodiment displays (on the Album Generator Interface) the image corresponding to the selected Image Object.
3. The embodiment displays (on the Album Generator Interface) the story and annotations that are part of the image or picture object.
4. The embodiment includes a method to name the image album.
5. The embodiment includes a method to display a list of keywords contained in the picture objects (examples are dates, locations, and proper names).
6. The embodiment includes a method to select all, only some, or no keywords required by search criteria.
7. The embodiment includes a method to add additional keywords that are not included in the anchor image.
8. Includes a method to run the search and produce a list of suggested Image Objects to become part of the album.
9. Include a method to exclude one or more of the selected images prior to generating the desired album.
10. The embodiment includes methods to embellish the album cover.
11. The embodiment includes a method to create the required album.

17. A method according to claim 1 presents the image album on the computer screen.

18. Methods according to claim 1 displays an album cover on the computer screen.

19. A method according to claim 1 displays a table of contents on the computer screen

20. A method according to claim 1 displays a table of contents on the computer screen.

21. A method according to claim 1 displays the album's index of key words on the computer screen.

22. A method according to claim 1 uses the computing pointing device (i.e. mouse, touch) to select a table of content item and display the corresponding Image Object on the computer screen.

23. A method according to claim 1 uses the computing pointing device (i.e. mouse, touch) to select an index item and display the corresponding Image Object on the computer screen.

24. A method according to claim 1 whereby displayed Image Objects include the ability to add, modify, or delete content from said Image Objects.

25. A method according to claim 1 prints albums and related Image Objects on the local or remote printer.

26. A method according to claim 1 wherein an Image Object provides the functionality to submit said object to a central WEB server.

27. The embodiment includes a method to record new members in the WEB server database.

28. The embodiment includes a method according to claim 1b that records key data belonging to the submitted object in the main index of the WEB server.

29. According to claim 1b, a submitted object automatically generates an index search and produces a list of Image Objects that bear a relation with the submitted one.

30. A method displays the hyperlink list of the related objects on the member's personal computing device.

31. A method displays the object selected from the hyperlink on the member's personal computing device.

32. A method stores the above-mentioned Image Object in the member's personal computing device.

33. A method according to claim 1 that allows anyone to search, view objects on the WEB server and optionally save said objects on a personal computing device.
